(19) United States
(12) Patent Application Publication
(10) Pub. No.: US 2016/0226097 A1
(43) Pub. Date: Aug. 4, 2016

(54) METHOD FOR MANUFACTURING A LITHIUM CELL FUNCTIONAL LAYER

(71) Applicant: ROBERT BOSCH GMBH, Stuttgart (DE)

(72) Inventors: Marcus Wegner, Leonberg (DE); Jean Fanous, Pfullingen (DE); Martin Tenzer, Nuertingen (DE)

(21) Appl. No.: 15/021,219

(22) PCT Filed: Sep. 5, 2014
(86) PCT No.: PCT/EP2014/068906

§ 371 Date: Mar. 10, 2016

(30) Foreign Application Priority Data
Sep. 27, 2013 (DE) 102013219602.4

(51) Int. Cl. H01M 10/0565; H01M 10/058; H01M 4/04; H01M 10/0525

(52) U.S. Cl. CPC H01M 10/0565; H01M 10/0525; H01M 10/058; H01M 4/04; H01M 2220/30; H01M 2220/20

(57) ABSTRACT

A method for manufacturing a lithium-ion conducting composite material, in particular a lithium-ion conducting functional layer for a lithium cell. The composite material or the functional layer is formed from a mass which includes particles of at least one inorganic material designed for forming a lithium-ion conducting network without sintering, and at least one polymeric binder. Functional layers of this type, a lithium cell, a lithium battery provided therewith, and to their use are also described.

### FIELD

The present invention relates to a manufacturing method, a composite material, functional layers for lithium cells, lithium cells and lithium batteries, and their use.

### BACKGROUND INFORMATION

In various types of lithium batteries, in particular the so-called post lithium-ion batteries, such as, for example, lithium-sulfur or lithium-oxygen batteries, a metallic lithium anode is utilized as the anode. On the anode, however, parasitic reactions with the electrolyte and/or the substances contained therein, for example, polysulfides in the case of a lithium-sulfur cell, may take place. In this case, both the electrolyte as well as the lithium itself may be consumed. If the secondary reactions thermally accelerate and hereby result in a runaway of the reactions, or if intergrowth of dendrites causes a short circuit of the cell, this may pose a safety risk for the cell.

### SUMMARY

The subject matter of the present invention is a method for manufacturing, in particular, a lithium-ion conducting composite material, for example, a lithium-ion conducting functional layer for a lithium cell. For example, the method may be a method for manufacturing a lithium-ion conducting protective layer for an anode of a lithium cell and/or a lithium-ion conducting separator layer for a lithium cell and/or a lithium-ion conducting protective layer for a cathode of a lithium cell and/or a lithium-ion conducting cathode layer for a lithium cell and/or a lithium-ion conducting anode layer for a lithium cell. For example, the method may be a method for manufacturing a lithium-ion conducting protective layer for a lithium metal anode.

A lithium cell may be understood to mean, in particular, an electrochemical cell, whose anode (negative electrode) includes lithium. For example, this may be a lithium metal cell, a cell having an anode (negative electrode) made of metallic lithium or a lithium alloy, or, if necessary, a lithium-ion cell, a cell whose anode (negative electrode) includes an intercalation material, for example, graphite, in which lithium is reversibly storable and removable. In particular, the lithium cell may be a lithium metal cell.

Within the scope of the example method, a composite material or a functional layer, in particular a protective layer, is formed of a mass which includes particles of at least one inorganic material designed for forming a lithium-ion conducting network without sintering, and at least one polymeric binder.

An inorganic material designed for forming a lithium-ion conducting network without sintering may be understood to be, in particular, an inorganic material, the particles of which may be utilized for forming a lithium-ion conducting network, in particular having a lithium-ion conductivity of >10⁻³ S/cm, also at temperatures of less than 1000° C., for example, of ≦600° C.

Layers having a high mechanical stability and good lithium-ion conductivity may be advantageously manufactured using the method. In particular, extremely thin layers, for example, of ≦20 μm, having good lithium-ion conductivity and an acceptable mechanical stability may be manufactured using the method. Layers manufactured by the method may therefore be advantageously utilized both for manufacturing large lithium cells, for example, for electrical equipment and vehicles, and, in particular, for manufacturing thin film batteries.

Given that an inorganic material designed for forming a lithium-ion conducting network without sintering is utilized, high-temperature post-treatment, for example, resintering, may be advantageously omitted, which is required for conventional ceramic materials, for example, lithium lanthanum titanium oxide (LLTO), lithium lanthanum titanium phosphate (LATP), garnets, such as lithium lanthanum zirconium oxide (LLZ), after the manufacture of a layer for forming particle contacts, for reducing the contact resistance from one particle to the next particle and, therefore, for ensuring a sufficiently high lithium-ion conductivity. This makes it possible, in turn, to manufacture the composite material or the functional layer at low temperatures, for example, of <1000° C., for example, of ≦600° C., and to process the composite material or the functional layer, for example, at room temperature. This makes it possible, in turn, for the at least one polymeric binder to remain in the layer, for example, without decomposing, which may go hand in hand with the advantages explained in the following and which is not possible in the case of conventional, ceramic lithium-ion conductors due to the necessary resintering.

Given that specifically one polymeric binder is utilized and, in particular, is not burnt out during a resintering, the mechanical stability of the composite material or the functional layer, specifically, may be advantageously improved and the flexibility of the composite material or the functional layer may be increased, in particular as compared to purely ceramic layers formed of conventional ceramic lithium-ion conductors, which generally exhibit a high brittleness. This advantageously makes it possible to more easily integrate the formation of a functional layer into a cell manufacturing process and to simplify the manufacturing method and, for example, to use simple and cost-effective coating methods and/or roll-to-roll methods.

The fact that the method does not require high-temperature post-treatment, for example, resintering, also has the advantage that the composite material or the functional layer may also be applied directly onto temperature-sensitive substrates, such as lithium, polymers, etc. This likewise makes it advantageously possible, in turn, to more easily incorporate the formation of a functional layer into a cell manufacturing process and to simplify the manufacturing method and, for example, to use simple and cost-effective coating methods and/or roll-to-roll methods.

In particular, by using the manufacturing method and, in particular, on the basis of the inorganic polymer composite formed therein, functional layers may be advantageously provided, which not only have a sufficiently high lithium-ion conductivity, but are also stable against dendrite growth. This makes it advantageously possible, in turn, to increase the safety of a cell provided with such a functional layer, for example, in that the functional layer is applied as a protective layer onto a metallic lithium anode, for example, in order to prevent direct contact between metallic lithium and electrolyte and/or to prevent dendrite growth, and to even omit a separator, if necessary.

For example, a protective layer for a lithium-sulfur cell or a lithium-sulfur battery or a lithium-oxygen cell or a lithium-oxygen battery or a lithium-ion cell or a lithium-ion battery, in particular a lithium-sulfur cell or a lithium-sulfur battery, may be manufactured using the method.

With the aid of the method, it is likewise possible, however, to manufacture a separator layer or a cathode layer or an anode layer for a lithium-sulfur cell or a lithium-sulfur battery or a lithium-oxygen cell or a lithium-oxygen battery or a lithium-ion cell or a lithium-ion battery.

Within the scope of one specific embodiment, the composite material or the functional layer, in particular the protective layer, is further processed at temperatures of less than 1000° C., in particular of ≦600° C. In particular, the composite material or the functional layer cannot be resintered.

The at least one inorganic material designed for forming a lithium-ion conducting network without sintering may be a ceramic material, if necessary.

For example, the composite material or the functional layer, in particular the protective layer, may be formed by applying the mass onto a substrate. This may be carried out, in particular, with the aid of a thin layer process. The mass may be a paste, for example. For example, the mass, for example, paste, may be applied onto a substrate using the manufacturing steps known in battery engineering. For example, an anode protective layer, in particular for a lithium cell, for example, of a lithium battery, may be applied onto a substrate, for example, directly onto an anode or initially onto a carrier substrate.

The mass, for example, a paste, may then be dried, if necessary.

The at least one inorganic material designed for forming a lithium-ion conducting network without sintering may be a material, in particular, in which a lithium-ion conducting network may be formed by compaction, in particular, pressing, without sintering.

For example, lithium-argyrodites and (other) sulfidic lithium-ion conductors may be suitable for this purpose.

Within the scope of one further specific embodiment, the at least one inorganic material designed for forming a lithium-ion conducting network without sintering is selected from the group of lithium-argyrodites and sulfidic lithium-ion conductors, for example, lithium-ion conducting, sulfidic glasses (sulfur glasses). In particular, within the scope of the method, a composite material or a functional layer may therefore be formed from a mass which includes particles at least of a material selected from the group of lithium-argyrodites and sulfidic lithium-ion conductors, for example, lithium-ion conducting, sulfidic glasses (sulfur glasses), and at least one polymeric binder.

Within the scope of one further specific embodiment, the at least one inorganic material designed for forming a lithium-ion conducting network without sintering is selected from the group of lithium-argyrodites. Lithium-argyrodites may advantageously have high lithium-ion conductivity and high chemical stability. In particular, within the scope of the method, a composite material or a functional layer may therefore be formed from a mass having particles at least of one material selected from the group of lithium-argyrodites, and at least one polymeric binder.

Lithium-argyrodites may be understood to be, in particular, compounds derived from the mineral argyrodite having the general chemical formula: Ag₈GeS₆, silver (Ag) being replaced by lithium (Li), and, in particular, germanium (Ge) and/or sulfur (S) also being replaceable by other elements, for example, from the main group III, IV, V, VI and/or VII.

### Examples of Lithium-Argyrodites are:

Compounds having the general chemical formula:

Li₇PCh₆

Ch standing for sulfur (S) and/or oxygen (O) and/or selenium (Se), for example, sulfur (S) and/or selenium (Se),
Compounds having the general chemical formula:

Li₆PCh₅X

Ch standing for sulfur (S) and/or oxygen (O) and/or selenium (Se), for example, sulfur (S) and/or oxygen (O), and X standing for chlorine (Cl) and/or bromine (Br) and/or iodine (I) and/or fluorine (F), for example, X standing for chlorine (Cl) and/or bromine (Br) and/or iodine (I),
Compounds having the general chemical formula:

Li_{7-δ}BCh_{6-δ}X_{δ}

Ch standing for sulfur (S) and/or oxygen (O) and/or selenium (Se), for example, sulfur (S) and/or selenium (Se), B standing for phosphorous (P) and/or arsenic (As), X standing for chlorine (Cl) and/or bromine (Br) and/or iodine (I) and/or fluorine (F), for example, X standing for chlorine (Cl) and/or bromine (Br) and/or iodine (I), and 0≦δ≦1.

For example, lithium-argyrodites having the chemical formulas: Li₇PS₆, Li₇PSe₆, Li₆PS₅Cl, Li₆PS₅Br, Li₆PS₅I, Li_{7-δ}PS_{6-δ}Cl_{δ}, Li_{7-δ}PS_{6-δ}Br_{δ}, Li_{7-δ}PS_{6-δ}I_{δ}, Li_{7-δ}PSe_{6-δ}Cl_{δ}, Li_{7-δ}PSe_{6-δ}Br_{δ}, Li_{7-δ}PSe_{6-δ}I_{δ}, Li_{7-δ}AsS_{6-δ}Br_{δ}, Li_{7-δ}AsS_{6-δ}I_{δ}, Li₆AsS₅I, Li₆AsSe₅I, Li₆PO₅Cl, Li₆PO₅Br, Li₆PO₅I are known.

Lithium-argyrodites are described, for example, in the publications: Angew. Chem. Int. Ed., 2008, 47, 755-758; Z. Anorg. Allg. Chem., 2010, 636, 1920-1924; Chem. Eur. J., 2010, 16, 2198-2206; Chem. Eur. J., 2010, 16, 5138-5147; Chem. Eur. J., 2010, 16, 8347-8354; Solid State Ionics, 2012, 221, 1-5; Z. Anorg. Allg. Chem., 2011, 637, 1287-1294; and Solid State Ionics, 2013, 243, 45-48.

In particular, the at least one inorganic material designed for forming a lithium-ion conducting network without sintering may be selected from the group of sulfur-containing or sulfidic lithium-argyrodites, for example, in which Ch stands for sulfur (S).

Examples of sulfidic lithium-ion conductors, in particular lithium-ion conducting, sulfidic glasses (sulfur glasses), are Li₁₀GeP₂S₁₂, Li₂S—(GeS₂)—P₂S₅ and Li₂S—P₂S₅.

In particular, germanium-containing, sulfidic lithium-ion conductors, for example, or lithium-ion conducting, germanium-containing, sulfidic glasses (sulfur glasses), for example, Li₁₀GeP₂S₁₂ and/or Li₂S—(GeS₂)—P₂S₅, in particular Li₁₀GeP₂S₁₂, may be utilized as sulfidic lithium-ion conductors. Germanium-containing, sulfidic lithium-ion conductors may advantageously have a high lithium-ion conductivity and a high chemical stability.

Lithium-argyrodites may be manufactured, in particular, using a mechanical-chemical reaction process, for example; starting materials, such as lithium halogenides, for example, LiCl, LiBr and/or LiI, and/or lithium chalcogenides, for example, Li₂S and/or Li₂Se and/or Li₂O, and/or chalcogenides of the main group V, for example, P₂S₅, P₂Se₅, Li₃PO₄, in particular in stoichiometric quantities, being milled with one another. This may be carried out, for example, in a ball mill, in particular in a high-energy ball mill, for example, having a speed of 600 rpm. In particular, the milling may be carried out in a protective atmosphere. In particular, the particles of the at least one inorganic material designed for forming a lithium-ion conducting network without sintering may therefore be milled, for example, before being introduced into the mass.

If necessary, the particles of the at least one inorganic material designed for forming a lithium-ion conducting network without sintering may be heated, for example, to a temperature of approximately 550° C., after milling and, in particular, prior to being introduced into the mass. After the heating, the particles of the at least one inorganic material designed for forming a lithium-ion conducting network without sintering may be milled again, if necessary. The milling after the heating may be carried out prior to the introduction into the mass and/or in the mass.

The particles of the at least one inorganic material designed for forming a lithium-ion conducting network without sintering may have an average particle size, for example, of ≦50 μm. Therefore, good lithium-ion conductivity of the lithium-ion conducting network may be advantageously achieved.

Within the scope of one further specific embodiment, the particles of the at least one inorganic material designed for forming a lithium-ion conducting network without sintering have an average particle size of ≦20 μm, in particular of ≦10 μm, for example, of ≦1 μm. Therefore, good lithium-ion conductivity of the lithium-ion conducting network may be advantageously achieved and, in addition, thin layers, for example of ≦20 μm, may be advantageously formed. Such average particle sizes may be obtained, for example, via a milling process.

Within the scope of one further specific embodiment, the mass includes, with respect to the solids content of the mass, ≧10 weight percent of the particles of the at least one inorganic material designed for forming a lithium-ion conducting network without sintering. In particular, the mass may include, with respect to the solids content of the mass, ≧60 weight percent, for example, ≧80 weight percent, for example, ≧80 weight percent of the particles of the at least one inorganic material designed for forming a lithium-ion conducting network without sintering. Therefore, high ion conductivity and high mechanical stability of the composite material or of the functional layer may be advantageously achieved.

Since the mass need not be subjected to high-temperature treatment, for example, resintering, and, therefore, the at least one polymeric binder may remain in the composite material or the functional layer, the composite material formed from the mass or the functional layer formed from the mass may also include, with respect to the solids content of the composite material or the functional layer, or with respect to the total weight of the composite material or the functional layer, ≧10 weight percent, in particular ≧60 weight percent, for example, ≧80 weight percent of the particles of the at least one inorganic material designed for forming a lithium-ion conducting network without sintering.

The at least one polymeric binder may include, in particular (an average of) ≧10,000 repeating units, for example, ≧15,000 repeating units. Improved adhesive properties and improved mechanical stability of the functional layer, in particular the protective layer, may therefore be advantageously achieved.

The at least one polymeric binder may be lithium-ion conducting or non-lithium-ion conducting.

For example, the at least one polymeric binder may be selected from the group of polyethers, fluorinated polymers, polysaccharides (or cellulose derivatives), intrinsically lithium-ion conducting polymers, epoxy resins, polyacrylates, and polystyrenes.

For example, the at least one polymeric binder may include or be polyethylene oxide (PEO) and/or polyvinylidene fluoride (PVdF) and/or polyglucosamine (chitosan) and/or a lithium salt of polystyrene sulfonic acid and/or epoxy resin and/or polyacrylate and/or polystyrene.

Such polymeric binders have proven, in particular, to be advantageous.

Within the scope of one further specific embodiment, the at least one polymeric binder is lithium-ion conducting. Boundary surfaces between the lithium-ion conducting, inorganic material and the lithium-ion conducting binder, and therefore, contact resistances as well, may therefore be advantageously minimized. In addition, not only may inorganic conducting paths be advantageously created in this way, but contact resistances to adjacent materials, for example, between the polymer of the composite material or the functional layer and a lithium-ion conducting polymer of an adjacent polymer-containing electrode, for example, a cathode or an anode, for example, an intercalation anode, for example, a graphite anode, may therefore be advantageously reduced, which cannot be ensured, for example, by multilayer concepts.

For example, the at least one binder may include an intrinsic lithium-ion conductor or may be intrinsically lithium-ion conducting. Lithium salts of polystyrene sulfonic acid may be, for example, intrinsically lithium-ion conducting.

In order to provide intrinsically non-lithium-ion conducting binders with lithium-ion conductivity or to increase the lithium-ion conductivity of an intrinsic lithium-ion conducting binder, a conducting salt, in particular a lithium conducting salt, may be additionally added. For example, by adding a lithium conducting salt, polyethylene oxide and/or polyglucosamine may be advantageously designed to be lithium-ion conducting, or the lithium-ion conductivity of lithium salts of polystyrene sulfonic acid may be increased.

The at least one binder may therefore also (itself) be non-lithium-ion conducting and may be designed to be lithium-ion conducting by the addition of at least one lithium conducting salt. For example, the at least one polymeric binder may include or be polyethylene oxide (PEO) and/or polyglucosamine (chitosan).

In particular, the at least one binder or the mass may therefore further include at least one conducting salt, in particular a lithium conducting salt. In particular, the composite material formed from the mass or the functional layer formed from the mass may also include at least one conducting salt, in particular lithium conducting salt. For example, the at least one conducting salt may be selected from the group made up of lithium hexafluorophosphate (LiPF₆), lithium bis(trifluormethanesulfonyl)imide (LiTFSl), lithium tetrafluoroborate (LiBF₄), lithium bis oxalato borate and mixtures thereof.

Within the scope of one further specific embodiment, the composite material or the functional layer is formed using a dry-coating method. For example, the composite material or the functional layer may be applied onto the substrate using a dry-coating method. Dry-coating methods have the advantage that solvents are not required. This may advantageously result in pores being reduced in size and, therefore, result in higher lithium-ion conductivity and a higher specific energy density. In addition, contaminations, in particular due to solvents, may therefore be advantageously avoided. In addition, dry-coating methods may be advantageously cost-effective. In particular, a dry-coating method, which is based on a melting process, for example, a pressing and melting process, may be utilized.

Within the scope of one further specific embodiment, the mass is solvent-free. Therefore, a reduction in size of pores and, therefore, a higher lithium-ion conductivity and a higher specific energy density may be advantageously achieved, and contaminations, in particular due to solvent, may be advantageously avoided.

Within the scope of one further specific embodiment, the at least one binder is meltable. Therefore, solvents may be advantageously omitted when forming the composite material or the functional layer, and the composite material or the functional layer may be advantageously formed using a dry-coating method on the basis of a melting process, for example, a pressing and melting process.

For example, the at least one polymeric binder may include or be polyethylene oxide (PEO) and/or polyvinylidene fluoride (PVdF). Polyethylene oxide and polyvinylidene fluoride are advantageously meltable.

In particular, the at least one polymeric binder may include or be polyethylene oxide (PEO). Polyethylene oxide is advantageously meltable and may be advantageously designed to be lithium-ion conducting by the addition of a lithium conducting salt.

Within the scope of another specific embodiment, the mass also includes a solvent or a solvent mixture. In particular, the at least one polymeric binder may be soluble in the solvent or solvent mixture. For example, a paste may be manufactured from finely milled lithium-argyrodite, for example, having an average particle size of ≦50 μm, one or multiple ionically conductive and/or ionically non-conductive polymeric binders, and a solvent or solvent mixture, in which, if necessary, only the binder or binders is/are soluble.

Within the scope of one further specific embodiment, the composite material or the functional layer is compacted, in particular pressed. Due to the compacting process or the pressing process, a dense layer may be advantageously manufactured and, in particular, any previously formed pores may be closed. Due to the compaction or pressing, in addition, the contact between the individual particles may be advantageously improved and, as a result, contact resistances may be minimized and, in particular, the lithium-ion conductivity may be increased in this way. In addition, the specific energy density may be advantageously increased. The compacting or pressing may be carried out, for example, with the aid of a compactor, for example, by calendering or with the aid of a calender.

In one embodiment of this specific embodiment, the compaction is carried out by cold pressing, in particular in a temperature range of <80° C. In particular, the composite material or the functional layer may be cold-pressed. The method may therefore advantageously be carried out easily and cost-effectively.

Within the scope of another embodiment of this specific embodiment, the compaction, in particular pressing, is carried out in a temperature range of ≧80° C. to ≦200° C. In particular, the compaction, for example, pressing, may be carried out at a temperature at which the at least one polymeric binder becomes flowable. The at least one polymeric binder may therefore advantageously better fill any pores which may have formed. For example, this may be carried out within the scope of a dry-coating method on the basis of a pressing and melting process.

Within the scope of one further embodiment of this specific embodiment, the compaction, in particular pressing, is carried out using a roll-to-roll process. The composite material or the functional layer may therefore be processed using a simple roll-to-roll process and may also be simultaneously manufactured, if necessary. A particularly simple coating method may therefore be advantageously implemented.

Within the scope of one further specific embodiment, the composite material or the functional layer is formed on a substrate, in particular by application of the mass. The composite material or the functional layer may therefore be advantageously manufactured in the form of a self-supporting or self-contained film or a self-supporting or self-contained layer, for example, an inorganic polymer composite layer, in particular made of inorganic particles including a polymeric binder. The composite material or the functional layer may then be transferred, via a relaminating process, from the substrate, for example, onto an anode, for example, a lithium metal anode, or a cathode. Within the scope of one embodiment of this specific embodiment, the composite material or the functional layer is therefore relaminated onto an anode or cathode or, if necessary, a separator.

Alternatively, it is possible to apply the mass directly onto an anode or cathode or, if necessary, a separator.

Within the scope of another specific embodiment, the composite material or the functional layer, in particular the protective layer, is therefore formed on an anode or cathode or a separator, in particular by application of the mass. The relaminating step may therefore be advantageously circumvented. Within the scope of this specific embodiment, during the compaction, for example, pressing of the composite material or the functional layer, in particular, the anode or the cathode may also be compacted or pressed. It may therefore be advantageously possible to minimize pores, reduce contact resistances, and increase the specific energy density. For example, a/the functional layer, for example, protective layer, may be applied directly onto an anode or cathode in a dry-coating method, for example, on the basis of a pressing and melting process.

With respect to further technical features and advantages of the method according to the present invention, reference is hereby explicitly made to the explanations in connection with the composite materials according to the present invention, the functional layers according to the present invention, the cell and battery according to the present invention, their use according to the present invention, and to the figures and the description of the figures.

A further subject matter of the present invention is a composite material or a functional layer, in particular a protective layer, for a lithium cell, manufactured using a method according to the present invention.

For example, the functional layer may be a protective layer for an anode of a lithium cell (anode protective layer) and/or a protective layer for a cathode of a lithium cell (cathode protective layer) and/or a, preferably the only, separator and/or a cathode and/or an anode for a lithium cell or of a lithium cell. For example, the functional layer may be a protective layer for a lithium metal anode.

Composite materials or layers manufactured according to the present invention may be distinguished, in particular, in that they contain a polymer or a binder, whereas layers manufactured using sinter-based methods do not include a polymer or a binder. As compared to layers manufactured via gas deposition, composite materials or layers manufactured according to the present invention may be distinguished, in particular, by a homogeneous structure or the lack of a layered structure and, in particular, by the presence of a, for example, three-dimensional, lithium-ion conducting network.

A further subject matter of the present invention is a composite material or a functional layer, in particular a protective layer, for a lithium cell, which includes at least one solid body lithium-ion conductor selected from the group of lithium-argyrodites and sulfidic, if necessary, germanium-containing, lithium-ion conductors, in particular at least one lithium-argyrodite, and at least one polymeric binder.

For example, the functional layer may be a protective layer for an anode of a lithium cell (anode protective layer) and/or a protective layer for a cathode of a lithium cell (cathode protective layer) and/or a, preferably the only, separator and/or a cathode and/or an anode for a lithium cell or of a lithium cell. For example, the functional layer may be a protective layer for a lithium metal anode.

Within the scope of one specific embodiment, the at least one polymeric binder includes (an average of) ≧10,000 repeating units, for example, ≧15,000 repeating units. Improved adhesive properties and improved mechanical stability of the functional layer, in particular the protective layer, may therefore be advantageously achieved in this way.

Within the scope of one specific embodiment, the at least one polymeric binder is selected from the group of polyethers, fluorinated polymers, polysaccharides, intrinsically lithium-ion conducting polymers, epoxy resins, polyacrylates, and polystyrenes. For example, the at least one polymeric binder may include or be polyethylene oxide (PEO) and/or polyvinylidene fluoride (PVdF) and/or polyglucosamine (chitosan) and/or a lithium salt of polystyrene sulfonic acid and/or epoxy resin and/or polyacrylate and/or polystyrene.

Such polymeric binders have proven, in particular, to be advantageous.

In particular, the functional layer may include a composite material according to the present invention or may be formed therefrom.

For example, the functional layer may be a protective layer for an anode of a lithium cell (anode protective layer) and/or a protective layer for a cathode of a lithium cell (cathode protective layer) and/or a, preferably the only, separator and/or a cathode and/or an anode for a lithium cell or of a lithium cell. For example, the functional layer may be a protective layer for a lithium metal anode.

Within the scope of one embodiment, the functional layer, in particular the protective layer, is a self-supporting or self-contained layer.

Within the scope of another embodiment, the functional layer, in particular the protective layer, is a coating applied onto an anode or cathode.

With respect to further technical features and advantages of the composite materials according to the present invention and the functional layers according to the present invention, reference is hereby explicitly made to the explanations in connection with the method according to the present invention, the cell and battery according to the present invention, their use according to the present invention, and to the figures and the description of the figures.

In addition, the present invention relates to a lithium cell or a lithium battery, which includes a composite material according to the present invention and/or (at least) one functional layer according to the present invention, in particular a protective layer. In the case of a lithium battery, this may include, in particular, a lithium cell, which includes a composite material according to the present invention and/or (at least) one functional layer according to the present invention, in particular a protective layer.

The cell may include, in particular, an anode (negative electrode) and a cathode (positive electrode)

The composite material or the functional layer may be utilized, for example, as an anode protective layer and/or a cathode protective layer and/or, in particular, the only separator and/or cathode and/or anode of the lithium cell.

The anode may include, in particular, a lithium metal anode, i.e., an anode including or formed from metallic lithium or a lithium alloy. However, the anode may also include a lithium intercalation material, if necessary.

The cathode may include, for example, sulfur, or may be an oxygen electrode. The lithium cell may be, in particular, a lithium-sulfur cell or a lithium-oxygen cell or the lithium battery may be a lithium-sulfur battery or a lithium-oxygen battery.

The cathode may also include a lithium intercalation material, however. The lithium cell may be, in particular, a lithium-ion cell or the lithium battery may be a lithium-ion battery.

If the functional layer is utilized as a protective layer or a separator, the layer may be situated, in particular, between the anode and the cathode. The functional layer may be utilized as a, in particular the only, separator of the lithium cell, if necessary. A high specific energy density may be advantageously achieved in this way. The functional layer, in particular the protective layer, may be applied, for example, on the side of the anode facing the cathode or on the side of the cathode facing the anode, or may be situated, as a self-supporting or self-contained layer, between the anode and the cathode.

Moreover, the cell may include an anode current collector, for example, made of copper, and a cathode current collector, for example, made of aluminum.

In particular, the lithium cell may be designed as a dry cell and/or a thin-layer cell or the lithium battery may be designed as a dry-cell battery and/or a thin-layer battery.

With respect to further technical features and advantages of the cell or the battery according to the present invention, reference is hereby explicitly made to the explanations in connection with the method according to the present invention, the composite materials according to the present invention, the functional layers according to the present invention, their use according to the present invention, and to the figures and the description of the figures.

The present invention further relates to the use of a composite material according to the present invention, a functional layer according to the present invention, in particular a protective layer, a cell according to the present invention and/or a battery according to the present invention in a power tool, a gardening tool, a computer, a notebook, a PDA, a cellular phone, a home energy storage system, a hybrid vehicle, a plug-in hybrid vehicle, and/or an electric vehicle. Due to the particularly high requirements in automotive applications, the composite materials according to the present invention, the functional layers according to the present invention, the cell according to the present invention, and/or the battery according to the present invention are particularly suitable for vehicles, for example, a hybrid vehicle, a plug-in hybrid vehicle, and/or an electric vehicle.

With respect to further technical features and advantages of the use according to the present invention, reference is hereby explicitly made to the explanations in connection with the method according to the present invention, the composite materials according to the present invention, the functional layers according to the present invention, the cell and battery according to the present invention, and to the figures and the description of the figures.

### BRIEF DESCRIPTION OF THE DRAWINGS

Further advantages and advantageous embodiments according to the present invention are illustrated in the figures and are explained below. It should be noted that the figures are merely descriptive and are not intended to restrict the present invention in any way.

FIG. 1 shows a schematic, perspective section from a specific embodiment of a composite material according to the present invention or a functional layer according to the present invention.

FIG. 2 shows a schematic cross section for illustrating a specific embodiment of a method according to the present invention for forming a composite material or a functional layer.

FIG. 3 shows schematic, enlarged cross-sectional details from FIG. 2 prior to and after compaction.

FIG. 4 shows a schematic cross section of a specific embodiment of a lithium cell according to the present invention.

### DETAILED DESCRIPTION OF EXAMPLE EMBODIMENTS

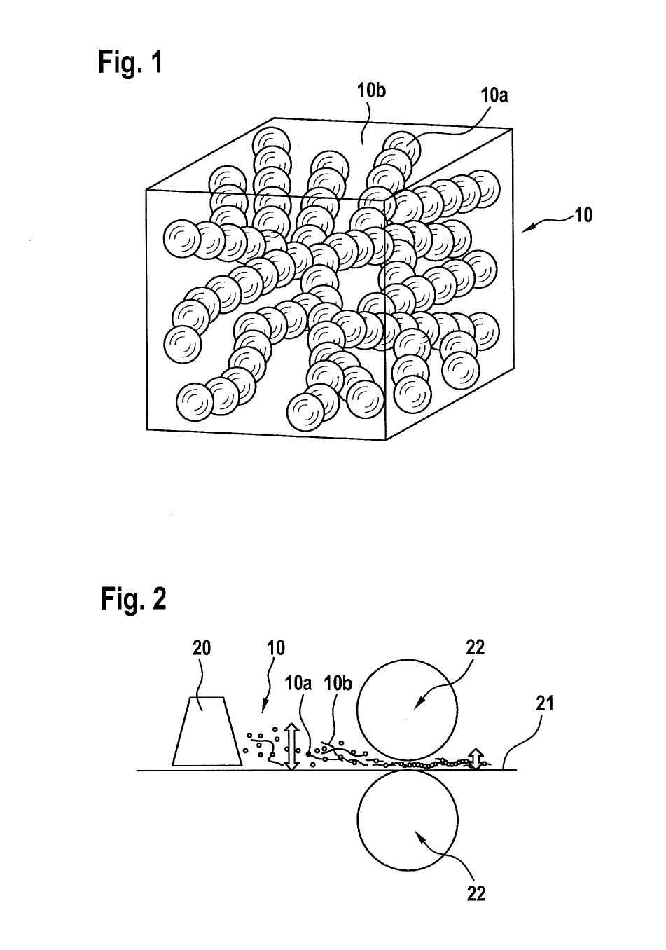

FIG. 1 shows that composite material 10 or a functional layer formed therefrom 10 includes inorganic particles 10a, which form a lithium-ion conducting network without sintering. FIG. 1 illustrates, in particular, that particles 10a have an in-line arrangement and directly contact one another, so that a three-dimensional network of lithium-ion conductive paths 10a results.

Particles 10a may be, for example, lithium-argyrodite particles 10a. The functional layer shown in FIG. 1 may be formed, for example, from an argyrodite 10a-binder 10b composite.

FIG. 1 shows that composite material 10 or a functional layer formed therefrom 10 also includes a polymeric binder 10b, which 10b is utilized as polymeric embedding material for particles 10a or the network formed therefrom. Polymeric binder 10b may be either ionically conductive or inert or non-ion-conductive.

FIG. 2 shows a specific embodiment of a method according to the present invention and illustrates that from a mass 10, which includes particles 10a of an inorganic material 10a designed for forming a lithium-ion conducting network without sintering, for example, lithium-argyrodite particles, and a polymeric binder 10b, a composite material, for example, in the form of a functional layer, is formed on a substrate 21, for example, using a scraper 20 or scrapers.

The arrows in FIG. 2 illustrate that the composite material or the functional layer is then compacted by a compactor 22. FIG. 2 shows, in particular, that the compaction is carried out, in particular, by calendering in a roll-to-roll process using a calender 22. The compaction of the composite material or the functional layer may be carried out, for example, at an elevated temperature, for example, in a temperature range of ≧80° C. to 200° C.

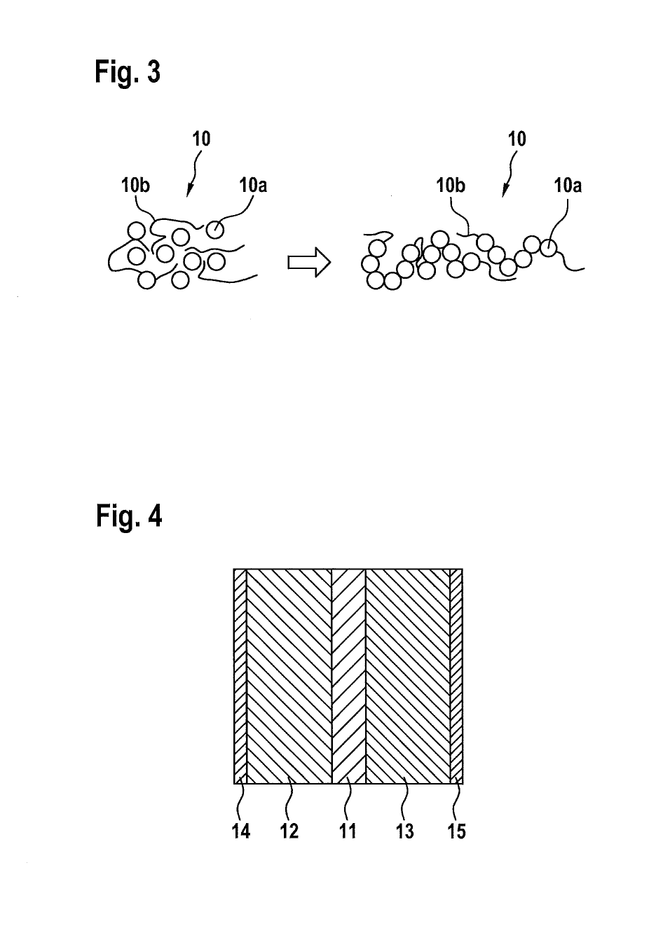

FIG. 3 shows schematic, enlarged cross-sectional details from FIG. 2 prior to and after compaction. FIG. 3 illustrates that inorganic particles 10a, which are not in contact with one another or are only slightly in contact with one another, are brought into contact with one another via the coating process, for example, by calendering.

FIG. 4 shows a schematic cross section of a specific embodiment of a lithium cell according to the present invention.

FIG. 4 shows that the cell includes an anode (negative electrode) 12 and a cathode (positive electrode) 13. Anode 11 includes an anode current collector 14, for example made of copper, and cathode 12 includes a cathode current collector 15, for example, made of aluminum.

FIG. 4 shows that a layer 11 is situated between anode 12 and cathode 13, which may be advantageously utilized as a protective layer for anode 12 and for cathode 13, in particular for preventing dendrite growth out of anode 11. Layer 11 may therefore also be referred to as an anode protective layer or as a cathode protective layer. In addition, layer 11 is utilized, in the specific embodiment shown in FIG. 4, as the only separator. Layer 11 may therefore also be referred to as a separator. A high specific energy density may therefore be advantageously achieved.

Protective layer 11 or separator 11 may be applied on the side of anode 12 facing cathode 13 or on the side of cathode 13 facing anode 12, or may be situated, as a self-supporting or self-contained layer, between anode 12 and cathode 13.

The lithium cell shown in FIG. 4 includes at least one of functional layers 11, 12, 13, for example, protective layer 11 or separator 11, anode 12 and/or cathode 13, a composite material according to the present invention, for example, an argyrodite-polymer composite, (see 10 in FIGS. 1 through 3) or is formed therefrom.

In particular, protective layer 11 or separator 11 may include or be formed from a composite material according to the present invention, for example, an argyrodite-polymer composite (see 10 in FIGS. 1 through 3). If necessary, cathode 13 and/or anode 12 may additionally include or be formed from a composite material according to the present invention, for example, an argyrodite-polymer composite (see 10 in FIGS. 1 through 3).

Anode 12 may also include, however, a lithium metal anode, i.e., an anode including or formed from metallic lithium or a lithium alloy. The cathode may include, for example, sulfur, or may be an oxygen electrode. For example, the lithium cell shown in FIG. 4 may be a lithium-sulfur cell or a lithium-oxygen cell. For example, the lithium cell shown in FIG. 4 may be designed as a dry cell and/or a thin layer cell.

1-17. (canceled)

18. A method for manufacturing a lithium-ion conducting functional layer for a lithium cell, comprising:
forming a composite material or a functional layer from a mass which includes particles at least of an inorganic material designed for forming a lithium-ion conducting network without sintering, and at least one polymeric binder.

19. The method as recited in claim 18, wherein the composite material or the functional layer is further processed at temperatures of less than 1000° C., and not being resintered.

20. The method as recited in claim 18, wherein the at least one inorganic material designed for forming a lithium-ion conducting network without sintering is selected from the group of lithium-argyrodites and sulfidic.

21. The method as recited in claim 18, wherein the at least one inorganic material designed for forming a lithium-ion conducting network without sintering includes germanium-containing lithium-ion conductors.

22. The method as recited in claim 21, wherein the at least one inorganic material is lithium-argyrodite.

23. The method as recited in claim 18, wherein the particles of the at least one inorganic material designed for forming a lithium-ion conducting network without sintering have an average particle size of less than or equal to 20 μm.

24. The method as recited in claim 18, wherein the mass, with respect to the solids content of the mass, includes more than or equal to 60 weight percent of the particles of the at least one inorganic material designed for forming a lithium-ion conducting network without sintering.

25. The method as recited in claim 18, wherein the at least one polymeric binder at least one of: i) includes at least one lithium conducting salt, and ii) is being intrinsically lithium-ion conducting.

26. The method as recited in claim 18, wherein the composite material or the functional layer is formed by a dry-coating method, the at least one polymeric binder being meltable and the mass being solvent-free, and the at least one polymeric binder being at least one of polyethylene oxide and polyvinylidene fluoride.

27. The method as recited in claim 18, wherein the composite material or the functional layer is compacted, the compaction being carried out in a temperature range of greater than or equal to 80° C. to less than or equal to 200° C.

28. The method as recited in claim 22, wherein the compaction is carried out using a roll-to-roll process.

29. The method as recited in claim 18, wherein one of: i) the composite material or the functional layer is formed on a substrate and is relaminated onto an anode or cathode, or ii) the composite material or the functional layer is formed on an anode, cathode, or a separator.

30. A composite material, manufactured by a method comprising:
forming a composite material or a functional layer from a mass which includes particles at least of an inorganic material designed for forming a lithium-ion conducting network without sintering, and at least one polymeric binder.

31. A composite material including at least one lithium-argyrodite and at least one polymeric binder.

32. The composite material as recited in claim 31, wherein the at least one polymeric binder has greater than or equal to 10,000 repeating units.

33. The composite material as recited in claim 31, wherein the at least one polymeric binder is selected from the group of polyethers, fluorinated polymers, polysaccharides, intrinsically lithium-ion conducting polymers, epoxy resins, polyacrylates, and polystyrenes.

34. A functional layer for a lithium cell, including a composite material, the composite material comprising at least one lithium-argyrodite and at least one polymeric binder.

35. The functional layer as recited in claim 34, wherein the functional layer is at least one of: i) an anode protective layer, and ii) a cathode protective layer, iii) a separator, iv) a cathode, v) an anode, and vi) a protective layer for a lithium metal anode.

36. A lithium cell or a lithium battery, including a composite material including at least one lithium-argyrodite and at least one polymeric binder.
